(19) United States
(12) Patent Application Publication
(10) Pub. No.: US 2026/0200463 A1
(43) Pub. Date: Jul. 16, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Takuya Niioka, Tokyo (JP); Yusuke Ogata, Tokyo (JP)

(21) Appl. No.: 19/445,679

(22) Filed: Jan. 12, 2026

(30) Foreign Application Priority Data
Jan. 16, 2025 (JP) 2025-006014

(51) Int. Cl. B60W 30/06; B60W 10/20; B60W 50/02; B60W 50/08

(52) U.S. Cl. CPC B60W 30/06; B60W 10/20; B60W 50/0225; B60W 50/08; B60W 2520/04; B60W 2520/10; B60W 2554/4041; B60W 2710/20; B60W 2720/106

(57) ABSTRACT

A vehicle control device includes a first sensor provided around a vehicle and configured to detect surroundings of the vehicle, a second sensor provided around the vehicle and configured to detect the surroundings of the vehicle, and a controller configured to control the vehicle. The first sensor can detect a situation of an area farther away than the second sensor. The second sensor has higher detection accuracy for a situation of a nearby area than the first sensor. In vehicle control for decelerating and stopping the vehicle, the controller gives priority to a detection result of the first sensor to execute the vehicle control when a speed of the vehicle is higher than or equal to a predetermined speed, and gives priority to a detection result of the second sensor to execute the vehicle control when the speed of the vehicle is lower than the predetermined speed.

### CROSS-REFERENCE TO RELATED APPLICATION

Priority is claimed on Japanese Patent Application No. 2025-006014, filed January 16, 2025, the content of which is incorporated herein by reference.

### BACKGROUND OF THE INVENTION

### FIELD OF THE INVENTION

The present invention relates to a vehicle control device, a vehicle control method, and a storage medium.

### DESCRIPTION OF RELATED ART

In recent years, efforts to provide sustainable transportation systems that consider various situations have become more active. For this realization, research and development (R&D) related to driving assistance technologies has focused on further improving traffic safety and convenience. For example, a travel control device for setting a travel path for evacuating a host vehicle to a roadside using the last detected travel environment information before the acquisition of travel environment information about a travel environment in which the host vehicle is traveling becomes abnormal as a target travel path and executing evacuation control for evacuating the host vehicle to the roadside in automated driving is known (see, for example, Japanese Patent No. 6025268). This travel control device executes the evacuation control using information about a physical object near the host vehicle, the last detected travel environment information before the acquisition of the travel environment information becomes abnormal and the travel information of the host vehicle when the physical object near the host vehicle is detected.

### SUMMARY OF THE INVENTION

In conventional technology, there is a case in which it is not possible to appropriately control a vehicle.

An aspect of the present invention provides a vehicle control device, a vehicle control method, and a storage medium that can enable a vehicle to be appropriately controlled. This aspect of the present invention contributes to the development of sustainable transportation systems.

A control device, a control method, and a storage medium according to the present invention adopt the following configurations.

(1): According to an aspect of the present invention, there is provided a vehicle control device including: a first sensor provided around a vehicle and configured to detect surroundings of the vehicle; a second sensor provided around the vehicle and configured to detect the surroundings of the vehicle; and a controller configured to control the vehicle, wherein the first sensor is configured to detect a situation of an area farther away than the second sensor, wherein the second sensor has higher detection accuracy for a situation of a nearby area than the first sensor, and wherein, in vehicle control for decelerating and stopping the vehicle, the controller gives priority to a detection result of the first sensor to execute the vehicle control when a speed of the vehicle is higher than or equal to a predetermined speed, and gives priority to a detection result of the second sensor to execute the vehicle control when the speed of the vehicle is lower than the predetermined speed.

(2): In the vehicle control device according to the above-described aspect (1), the second sensor is a sensor configured to detect the surroundings of the vehicle when the vehicle is parked or departs from a parking space.

(3): In the vehicle control device according to the above-described aspect (1), the second sensor detects an area on a side of the vehicle in a travel direction, and, in the vehicle control for decelerating and stopping the vehicle, the controller causes the vehicle to laterally move to an area where the vehicle can move to the side by controlling steering of the vehicle based on the detection result of the second sensor.

(4): In the vehicle control device according to the above-described aspect (3), when a preceding vehicle is located in the travel direction of the vehicle, the controller controls a position of the vehicle in a front-rear direction in the vehicle control based on information about the preceding vehicle included in the detection result of the first sensor, and executes first lateral movement control for laterally moving the vehicle in the vehicle control based on the detection result of the second sensor.

(5): In the vehicle control device according to the above-described aspect (3), the controller executes second lateral movement control for laterally moving the vehicle and, based on a position after the lateral movement, further moving the vehicle to an area in a lateral direction where the vehicle is movable found in a search based on the detection result of the second sensor.

(6): In the vehicle control device according to the above-described aspect (1), the controller stops the vehicle when a predetermined time has elapsed after a start of execution of the vehicle control or when the vehicle has traveled a predetermined distance.

(7): In the vehicle control device according to the above-described aspect (1), the controller starts the vehicle control when an abnormality has occurred in a driver of the vehicle.

(8): In the vehicle control device according to the above-described aspect (1), the controller starts the vehicle control when an abnormality has occurred in the vehicle or in a driver of the vehicle, gives the priority to the detection result of the first sensor to execute the vehicle control and searches for a candidate for a stopping area for stopping the vehicle by preferentially using the detection result of the first sensor, when the speed of the vehicle is higher than or equal to the predetermined speed, and gives the priority to the detection result of the second sensor to execute the vehicle control and causes the vehicle to laterally move to a candidate for the stopping area or a nearby area of the candidate for the stopping area, when the speed of the vehicle is lower than the predetermined speed.

(9): According to another aspect of the present invention, there is provided a vehicle control device including: a first sensor provided around a vehicle and configured to detect surroundings of the vehicle; a second sensor provided around the vehicle and configured to detect the surroundings of the vehicle; and a controller configured to control the vehicle, wherein the first sensor is configured to detect a situation of an area farther away than the second sensor, wherein the second sensor has higher detection accuracy for a situation of a nearby area than the first sensor, and wherein, in vehicle control for decelerating and stopping the vehicle when an abnormality has occurred in the vehicle or a driver of the vehicle, the controller decreases a priority level for using a detection result of the first sensor and increases a priority level for using a detection result of the second sensor in accordance with a decrease in a speed of the vehicle after a start of the vehicle control or in accordance with an elapse of time from the start of the vehicle control, thereby recognizing the surroundings of the vehicle and causing the vehicle to stop based on a recognition result.

(10): According to yet another aspect of the present invention, there is provided a vehicle control method including: in vehicle control for decelerating and stopping a vehicle, giving, by a computer, priority to a detection result of a first sensor and executing the vehicle control when a speed of the vehicle is higher than or equal to a predetermined speed; and giving, by the computer, priority to a detection result of a second sensor and executing the vehicle control when the speed of the vehicle is lower than the predetermined speed, wherein the first sensor, which is provided around the vehicle and detects surroundings of the vehicle, is configured to detect a situation of an area farther away than the second sensor, and wherein the second sensor, which is provided around the vehicle and detects the surroundings of the vehicle, has higher detection accuracy for a situation of a nearby area than the first sensor.

(11): According to yet another aspect of the present invention, there is provided a storage medium storing a program for causing a computer to execute: in vehicle control for decelerating and stopping a vehicle, a process for giving priority to a detection result of a first sensor to execute the vehicle control when a speed of the vehicle is higher than or equal to a predetermined speed; and a process for giving priority to a detection result of a second sensor to execute the vehicle control when the speed of the vehicle is lower than the predetermined speed, wherein the first sensor, which is provided around the vehicle and detects surroundings of the vehicle, is configured to detect a situation of an area farther away than the second sensor, and wherein the second sensor, which is provided around the vehicle and detects the surroundings of the vehicle, has higher detection accuracy for a situation of a nearby area than the first sensor.

According to the aspects (1) to (11), in the vehicle control device, vehicle control method, or storage medium, it is possible to appropriately control the vehicle by changing the detection result of the sensor to be preferentially used in accordance with the speed. For example, because the appropriate detection result of the sensor is used in accordance with the speed, appropriate vehicle control can be implemented using the detection result.

According to the aspect (2), because the second sensor is a sensor to be used when the vehicle is parked or departs from a parking space, appropriate vehicle control can be implemented without providing a separate sensor for vehicle control.

According to the aspect (3), because the vehicle is laterally moved using the detection result of the second sensor, which can accurately detect an area on the side of the vehicle, more appropriate vehicle control can be implemented.

According to the aspect (4), a position of the vehicle in the front-rear direction is more appropriately controlled using the detection result of the first sensor, which can accurately detect a preceding vehicle.

According to the aspect (5), after the vehicle is moved laterally, it is possible to move the vehicle to a more appropriate position by further laterally moving the vehicle using the detection result of the second sensor capable of more appropriately detecting an area on the side of the vehicle.

According to the aspect (6), the vehicle control device can stop the vehicle at an appropriate position.

### BRIEF DESCRIPTION OF THE DRAWINGS

FIG. 1 is a configuration diagram of a vehicle system using a vehicle control system according to an embodiment.

FIG. 2 is an explanatory diagram of an example of an arrangement configuration of sensors.

FIG. 3 is a diagram showing an example of a second detection range of a surround camera, a multi-view camera (MVC), and a sonar (second sensor group).

FIG. 4 is an explanatory diagram of a process executed by a driving assistance device.

FIG. 5 is an explanatory diagram of an example of a process of switching a priority level.

FIG. 6 is a flowchart showing an example of a flow of the process executed by the driving assistance device.

### DETAILED DESCRIPTION OF THE INVENTION

### Overall configuration

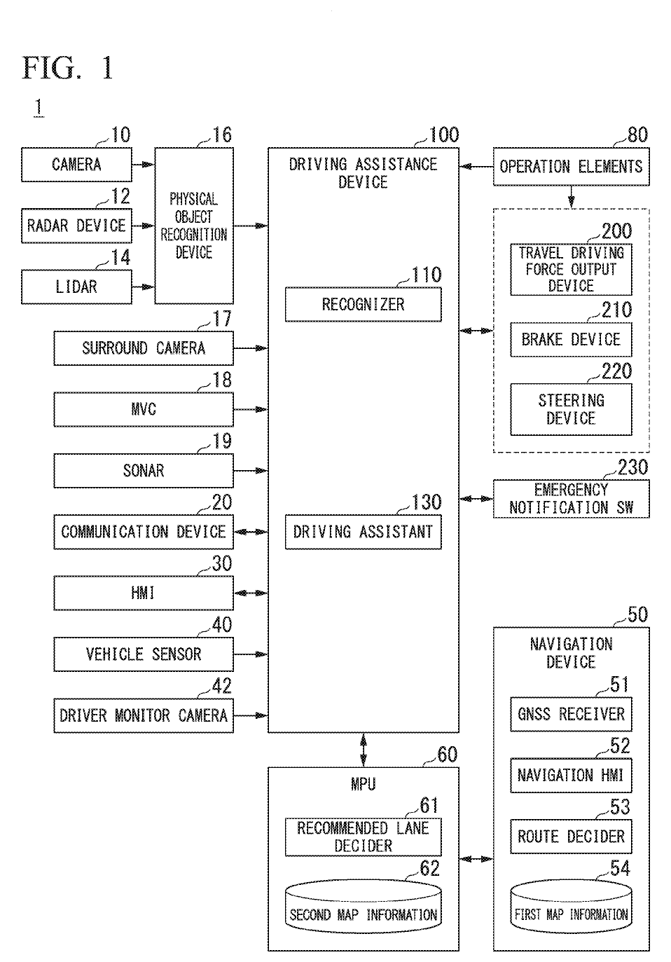

FIG. 1 is a configuration diagram of a vehicle system 1 using a vehicle control system according to an embodiment. A vehicle on which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged. Although the case where the present embodiment is applied to a vehicle will be described, the present invention may be applied to other mobile objects instead of a vehicle.

For example, the vehicle system 1 includes a camera 10, a radar device 12, a light detection and ranging (LIDAR) 14, a physical object recognition device 16, a surround camera 17, a multi-view camera (MVC) 18, a sonar 19, a communication device 20, a human machine interface (HMI) 30, a vehicle sensor 40, a driver monitor camera 42, a navigation device 50, a map positioning unit (MPU) 60, operation elements 80, a driving assistance device 100, a travel driving force output device 200, a brake device 210, a steering device 220, and an emergency notification switch (SW). Such devices and equipment are connected to each other by a multiplex communication line such as a controller area network (CAN) communication line, a serial communication line, or a wireless communication network. The configuration shown in FIG. 1 is merely an example and some of the constituent elements may be omitted or other constituent elements may be further added. The driving assistance device 100 is an example of a “control device.”

For example, the camera 10 is a digital camera using a solid-state imaging element such as a charge-coupled device (CCD) or a complementary metal oxide semiconductor (CMOS). The camera 10 is attached to any location on a vehicle (hereinafter, a vehicle M) where the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position of a physical object (a distance from the physical object and a direction of the physical object) by detecting radio waves (reflected waves) reflected by the physical object. The radar device 12 is attached to any location on the vehicle M. The radar device 12 may detect a position and a speed of the physical object in a frequency-modulated continuous wave (FM-CW) scheme.

The LIDAR 14 radiates light (or electromagnetic waves having a wavelength close to that of light) around the vehicle M and measures scattered light. The LIDAR 14 detects a distance from a target based on a period of time from light emission to light reception. The radiated light is, for example, pulsed laser light. The LIDAR 14 is attached to any location of the vehicle M.

The physical object recognition device 16 performs a sensor fusion process on detection results from some or all of the camera 10, the radar device 12, and the LIDAR 14 to recognize a position, type, speed, and the like of the physical object. The physical object recognition device 16 outputs a recognition result to the driving assistance device 100. The physical object recognition device 16 may output detection results of the camera 10, the radar device 12, and the LIDAR 14 to the driving assistance device 100 as they are. The physical object recognition device 16 may be omitted from the vehicle system 1. The physical object recognition device 16 may recognize physical objects using information of the surround camera 17, the MVC 18, or the sonar 19.

The surround camera 17 is a camera installed in an area near the vehicle body (the main body of the vehicle M), including at least the left, right, and rear sides. The surround camera 17 may be, for example, a digital camera using a solid-state imaging element such as a CCD or CMOS, or a stereo camera. The surround camera 17 acquires an image of an area including the side and rear of the vehicle M within at least approximately several meters [m] from the left, right, and rear sides (including an upper side of the vehicle M). Moreover, the surround camera 17 may capture images of the entire surroundings of the vehicle M, including images captured by the camera 10.

The MVC 18 is a camera installed on the front, rear, left, or right side of the vehicle body. The MVC 18 may be, for example, a digital camera using a solid-state imaging element such as a CCD or CMOS, or may be a stereo camera. The MVC 18 may be a wide-angle camera such as a fisheye camera (a camera with a wider imaging range than the surround camera 17 or the camera 10). The MVC 18 captures an image of an area near the vehicle M (mainly near the ground). The MVC 18, for example, captures images of areas that are blind spots for the driver of the vehicle M.

The sonar 19 radiates ultrasonic waves around the vehicle M and detects reflections or scattering by a physical object within a predetermined distance from the vehicle M, thereby detecting a distance from the physical object, a position of the physical object, and the like. A plurality of sonars 19 may be installed at any locations on the vehicle M.

The communication device 20, for example, communicates with another vehicle located in the vicinity of the vehicle M using a cellular network, a Wi-Fi network, Bluetooth (registered trademark), dedicated short-range communication (DSRC), or the like or communicates with various types of server devices via a radio base station.

The HMI 30 presents various types of information to an occupant of the vehicle M and receives an input operation from the occupant. The HMI 30 includes various types of display devices, a speaker, a buzzer, a touch panel, a switch, keys, and the like. The HMI 30 includes a display device. The display device is, for example, a display device, i.e., a multi-information display, configured to display various information in the vehicle M such as a speedometer indicating a traveling speed of the vehicle M or a tachometer indicating the number of rotations (a rotational speed) of the internal combustion engine provided in the vehicle M.

The vehicle sensor 40 includes a vehicle speed sensor configured to detect the speed of the vehicle M, an acceleration sensor configured to detect acceleration, a yaw rate sensor configured to detect angular velocity around a vertical axis, a direction sensor configured to detect an orientation of the vehicle M, and the like.

The driver monitor camera 42 is a camera that captures an image of the driver of the vehicle M. The driver monitor camera 42 is mounted at a position where the driver is captured from the front inside the vehicle M.

For example, the navigation device 50 includes a global navigation satellite system (GNSS) receiver 51, a navigation HMI 52, and a route decider 53. The navigation device 50 holds first map information 54 in a storage device such as a hard disk drive (HDD) or a flash memory. The GNSS receiver 51 identifies a position of the vehicle M based on a signal received from a GNSS satellite. The position of the vehicle M may be identified or complemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route decider 53 decides a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may provide route guidance using the navigation HMI 52 based on the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

The MPU 60 includes, for example, a recommended lane decider 61, and holds second map information 62 in a storage device such as an HDD or a flash memory. The recommended lane decider 61 divides the route on the map provided from the navigation device 50 into a plurality of blocks (e.g., divides the route every 100 [m] in a travel direction of the vehicle), and decides a recommended lane for each block with reference to the second map information 62. The recommended lane decider 61 decides in what lane numbered from the left the vehicle will travel. The recommended lane decider 61 decides the recommended lane so that the vehicle M can travel along a reasonable route for traveling to a branching destination when there is a branch point on the route on the map. For example, when the vehicle M reaches a position that is a predetermined distance before a branch path that the vehicle M is scheduled to enter, the recommended lane decider 61 decides a lane connecting to the branch path as the recommended lane. The recommended lane decider 61 and the second map information 62 may be a functional unit or information included in another device such as the driving assistance device 100. The driving assistance device 100 recommends the driver to move the vehicle M to the recommended lane or automatically moves the vehicle M.

The second map information 62 is map information with higher accuracy than the first map information 54. The second map information 62 includes, for example, information about a center of a lane, information about a boundary of the lane, or the like. The second map information 62 may include road information, traffic regulation information, address information (address/postal code), facility information, telephone number information, and the like. The second map information 62 may be updated at any time by the communication device 20 communicating with other devices.

The operation elements 80 include, for example, a steering wheel, an accelerator pedal, a brake pedal, a shift lever, and other operation elements. A sensor for detecting an amount of operation or the presence or absence of an operation is attached to the operation element 80 and a detection result thereof is output to the driving assistance device 100 or some or all of the travel driving force output device 200, the brake device 210, and the steering device 220. The steering wheel does not necessarily have to be annular and may be in the form of a variant steering wheel, a joystick, a button, or the like.

The driving assistance device 100 includes, for example, a recognizer 110, a driving assistant 130, and a storage 180. The recognizer 110 and the driving assistant 130 are implemented, for example, by a hardware processor such as a central processing unit (CPU) executing a program (software). Some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The program may be pre-stored in the storage 180 (a storage device including a non-transitory storage medium) such as an HDD or a flash memory in the driving assistance device 100 or may be stored in a removable storage medium such as a DVD or a CD-ROM and installed in an HDD or a flash memory of the driving assistance device 100 when the storage medium (the non-transitory storage medium) is mounted in a drive device.

On the basis of information input from the camera 10, the radar device 12, and the LIDAR 14 via the physical object recognition device 16 and information from the surround camera 17, the MVC 18, the sonar 19, or some or all of these, the recognizer 110 recognizes a state of a position, velocity, acceleration, or the like of a physical object in the vicinity of the vehicle M. The position of the physical object, for example, is recognized as a position of an absolute coordinate system having a representative point of the vehicle M (a center of gravity, a drive shaft center, or the like) as the origin, and is used for control. The position of the physical object may be represented by a representative point such as the center of gravity or a corner of the physical object or may be represented by an area. The “state” of the physical object may include the acceleration or jerk of the physical object, or the “action state” (e.g., whether or not the vehicle is changing lanes or is about to change lanes).

The recognizer 110 recognizes a lane in which the vehicle M is traveling (a travel lane). For example, the recognizer 110 recognizes the travel lane by comparing a pattern of road markings (e.g., an arrangement of solid lines and broken lines) obtained from the second map information 62 with a pattern of road markings in the vicinity of the vehicle M recognized from an image captured by the camera 10. The recognizer 110 may recognize the travel lane by recognizing a travel path boundary (a road boundary) including a road marking, a road shoulder, a curb, a median strip, a guardrail, and the like as well as a road marking. In this recognition, a position of the vehicle M acquired from the navigation device 50 or a processing result of the INS may be taken into account. The recognizer 110 recognizes a temporary stop line, an obstacle, a red traffic light, and a toll gate, and other road events.

When the travel lane is recognized, the recognizer 110 recognizes a position or an orientation of the vehicle M with respect to the travel lane. For example, the recognizer 110 may recognize a deviation of a reference point of the vehicle M from the center of the lane and an angle formed between the travel direction of the vehicle M and a line connected to the center of the lane as a relative position and orientation of the vehicle M related to the travel lane. Alternatively, the recognizer 110 may recognize the position of the reference point of the vehicle M for any side end of the travel lane (the road marking or the road boundary) or the like as a position of the vehicle M relative to the travel lane.

The driving assistant 130 executes driving assistance control. For example, the driving assistant 130 automatically controls the travel driving force output device 200 and the brake device 210 without relying on the driver’s operation, thereby automatically controlling the speed of the vehicle M. The driving assistant 130 executes so-called adaptive cruise control (ACC). The driving assistant 130 controls the vehicle M so that the vehicle M travels at a set speed, or causes the vehicle M to travel while tracking a preceding vehicle at a predetermined distance from the preceding vehicle.

The driving assistant 130 controls the steering device 220 so that the vehicle M does not deviate from the travel lane. For example, the driving assistant 130 controls the steering device 220 so that the vehicle M travels near or along the center of the travel lane recognized by the recognizer 110. This control may hereinafter be referred to as “lane keeping control.”

The travel driving force output device 200 outputs a travel driving force (torque) for enabling the traveling of the vehicle to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the driving assistance device 100 or information input from the operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the driving assistance device 100 or the information input from the operation element 80 so that brake torque according to a braking operation is output to each wheel.

For example, the steering device 220 includes a steering ECU and an electric motor. For example, the electric motor changes directions of steerable wheels by applying a force to a rack and pinion mechanism. The steering ECU drives the electric motor in accordance with the information input from the driving assistance device 100 or the information input from the operation element 80 to change the directions of the steerable wheels.

The emergency notification SW 230, for example, is attached to a position where the emergency notification SW 230 can be operated by the driver or the occupant of the passenger seat in the vehicle cabin of the vehicle M. The emergency notification SW, for example, may be attached to the ceiling between the driver seat and the passenger seat. The driver or occupant operates the emergency notification SW when an abnormality occurs in the driver, the vehicle M, or the like. The driving assistance device 100 controls the vehicle M so that the vehicle M can safely stop based on a signal according to the operation.

### Arrangement of sensors

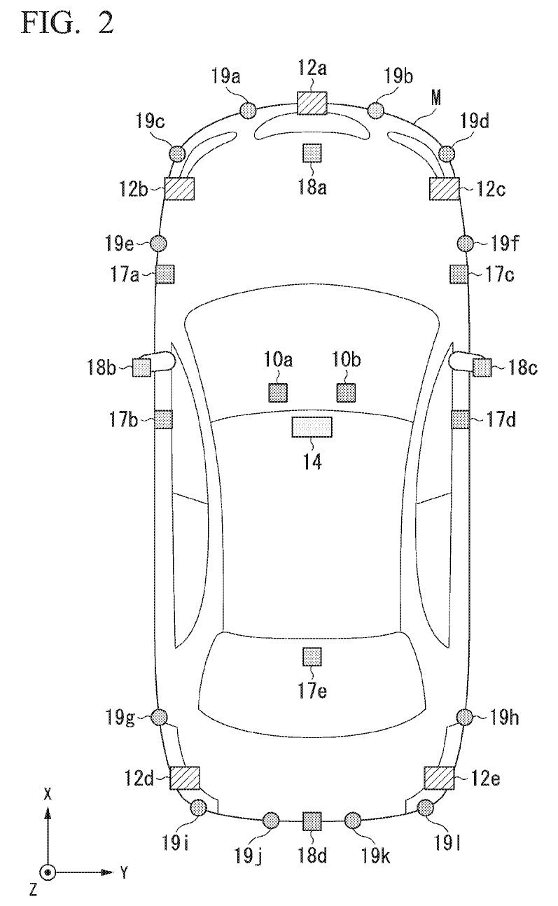

An example of an arrangement configuration of sensors will be described. FIG. 2 is an explanatory diagram of an example of an arrangement of the sensors according to the embodiment. In the example shown in FIG. 2, two cameras 10a and 10b, five radar devices 12a to 12e, one LIDAR 14, five surround cameras 17a to 17e, four MVCs 18a to 18d, and twelve sonars 19a to 19l are provided in the vehicle M. Hereinafter, the radar devices 12a to 12e are referred to as “radar devices 12” unless described individually. The same is true for the cameras 10a and 10b, the surround cameras 17a to 17e, the MVCs 18a to 18d, and the sonars 19a to 19l.

The cameras 10a and 10b, for example, are installed on an upper portion of the front windshield, a rear surface of the room mirror, and the like and image an area including the front of the vehicle M. One of the cameras 10a and 10b may be a telephoto camera capable of capturing a distant area. Moreover, one of the cameras 10a and 10b may be a main camera that operates under normal conditions and the other may be a sub-camera that captures images in situations where the main camera cannot capture images. The imaging ranges of the cameras 10a and 10b may partially overlap.

The radar device 12a is installed near the front end portion of the vehicle body and detects a physical object located in front of the vehicle M. The radar device 12b is installed near the left front portion of the vehicle body and detects a physical object located in the left front direction and the left side direction from the vehicle M. The radar device 12c is installed near a right front portion of the vehicle body and detects a physical object located in the right front direction and the right side direction from the vehicle M. The radar device 12d is installed near a left rear portion of the vehicle body and detects a physical object located in the left rear direction and the left side direction from the vehicle M. The radar device 12e is installed near a right front portion of the vehicle body and detects a physical object located in the right front direction and the right side direction from the vehicle M. Sizes of the detection ranges of the radar devices 12a to 12e may be the same. Detection ranges of the radar devices 12a to 12e may partially overlap.

The LIDAR 14 is installed on the upper portion (roof) of the vehicle body and detects a physical object located in an area including the front direction (an X-axis direction in the drawing) from the vehicle M.

The surround cameras 17a and 17b are installed on the left side of the vehicle body (the main body of the vehicle M) and capture an area including the left side direction (a −Y-axis direction in the drawing) from the vehicle M. The surround cameras 17c and 17d are installed on the right side of the vehicle body and image an area including the right side direction (a Y-axis direction in the drawing) from the vehicle M. The surround camera 17e is provided on the upper portion of the rear windshield of the vehicle M (near the roof thereof) and images an area including the rear direction (a −X-axis direction in the drawing) from the vehicle M. Magnitudes of angles of view (imaging ranges) of the surround cameras 17a to 17e may be the same. The imaging ranges of the surround cameras 17a to 17e may partially overlap.

The MVC 18a is installed on the front portion of the vehicle body and images an area including the front direction from the vehicle M. The MVC 18b is installed near a left side mirror of the vehicle M and images an area including the left side direction from the vehicle M. The MVC 18c is installed near a right side mirror of the vehicle M and images an area including the right side direction from the vehicle M. The MVC 18d is installed on the rear portion of the vehicle body and images an area including the rear direction from the vehicle M. Magnitudes of angles of view of the MVCs 18a to 18d may be the same. Imaging ranges of the MVCs 18a to 18d may partially overlap.

The sonars 19a to 19l, for example, are installed in bumpers or the like provided on front and rear end portions of the vehicle body. The sonars 19a and 19b are installed on the front end portion of the vehicle body, the sonars 19c and 19d are installed on the front-side end portion, and the sonars 19e and 19f are installed on the left and right sides of the front portion of the vehicle body. The sonars 19g and 19h are installed on the left and right sides of the rear portion of the vehicle body, and the sonars 19i, 19j, 19k, and 19l are installed on the rear end portion of the vehicle body. The sonars 19a to 19l detect physical objects located near the vehicle M. Sizes of the detection ranges of the sonars 19a to 19l may be the same. Detection ranges of the sonars 19a to 19l may partially overlap.

In addition, the number and installation positions of the sensors are not limited to the example shown in FIG. 2. For example, according to the grade, generation (version), or function of the vehicle M and the like, at least some installation positions may be different, the number of sensors may be different, or some sensors may be added or removed, or the types of sensors may be different.

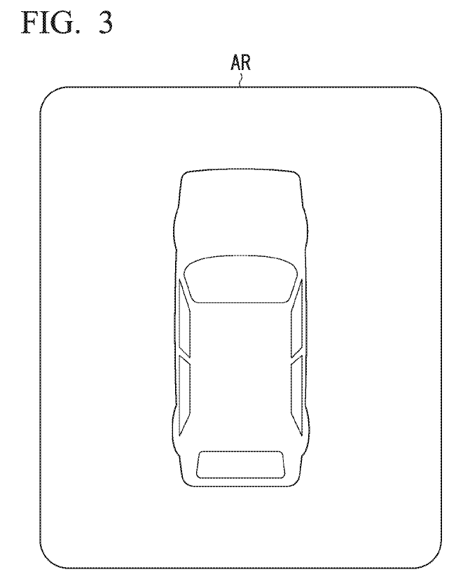

FIG. 3 is a diagram showing an example of a second detection range AR of the surround cameras 17, the MVCs 18, and the sonars 19. The surround cameras 17, the MVCs 18, and the sonars 19, or some or all of these are examples of “second sensors.” The second sensors are examples of “sensors that detect the surroundings of the vehicle when the vehicle is parked or departing from a parking space.” The cameras 10, the radar device 12, the LIDAR 14, or some or all of these are examples of “first sensors.”

In the example shown in FIG. 3, the second sensors have the same detection range, but the detection range is not limited thereto and may be set differently. The second sensors can mainly detect areas near the vehicle M with higher detection accuracy than the first sensors to be described below. For example, the second sensors can perform detection in the second detection range AR, for example, a range of approximately 3 to 4 meters from the vehicle M, with higher accuracy than the first sensors.

The first detection range of the cameras 10, the radar devices 12, and the LIDAR 14 may include the second detection range AR, or may be a range different from the second detection range AR. The first detection range, for example, is wider than the second detection range AR. For example, the first sensor can detect the first detection range that is farther away than that of the second sensor with higher accuracy. The first sensor can mainly detect an area distant from the vehicle M and has higher detection accuracy at a distance than the second sensor. For example, the first sensor can detect a range farther than approximately 3 to 4 meters from the vehicle M with higher accuracy than the second sensor.

### Overview

For example, in the vehicle control for decelerating and stopping the vehicle M, the driving assistance device 100 gives priority to a detection result of the first sensor to execute the vehicle control when a speed of the vehicle M is higher than or equal to a predetermined speed and gives priority to a detection result of the second sensor to execute the vehicle control when the speed of the vehicle M is lower than the predetermined speed. The driving assistance device 100, for example, may start the vehicle control when an abnormality has occurred in the vehicle M or in a driver of the vehicle M, give priority to the detection result of the first sensor to execute the vehicle control and search for a candidate for a stopping area for stopping the vehicle M by preferentially using the detection result of the first sensor, when the speed of the vehicle M is higher than or equal to the predetermined speed, and give priority to the detection result of the second sensor to execute the vehicle control and cause the vehicle M to laterally move to a candidate for the stopping area or a nearby area of the candidate for the stopping area, when the speed of the vehicle M is lower than the predetermined speed.

The vehicle control is, for example, control that is executed when an abnormality has occurred in the vehicle M or in the driver of the vehicle M. The vehicle control is, for example, control for decelerating and stopping the vehicle M when an abnormality has occurred in the vehicle M or in the driver.

The abnormality is a state in which the vehicle M is unable to travel normally or a state in which the driver cannot continue driving operations. The state in which the vehicle M is unable to travel normally is a state in which an abnormality has occurred in the vehicle system 1 (a functional configuration not involved in vehicle control) and is, for example, a state in which a flag indicating that an abnormality has occurred in the vehicle system 1 has been generated. An abnormality of the driver is a situation where the occurrence of the abnormality of the driver has been detected from the detection result of the driver monitor camera 42 (e.g., the forward visual recognition has not continued for a predetermined time), a situation in which a state in which the driver is not grasping the steering wheel continues for a predetermined time (a situation in which the grasping sensor of the vehicle system 1 has not continuously detected grasping for a predetermined time), a situation where the emergency notification SW 230 has been operated, or the like.

The first sensor is, for example, the radar device 12. The first sensor may be one or both of the camera 10 and the LIDAR 14 in place of (or in addition to) the radar device 12. Alternatively, in addition to the radar device 12, one or both of the camera 10 and the LIDAR 14 may be included as the first sensor.

The second sensor is, for example, the sonar 19. The second sensor may be one or both of the surround camera 17 and the MVC 18 instead of the sonar 19. Alternatively, in addition to the sonar 19, one or both of the surround camera 17 and the MVC 18 may be included as the second sensor.

It is only necessary for the second sensor to be, for example, a sensor that detects the surroundings of the vehicle to be used when the vehicle M is parked or departs from a parking space. It is only necessary for the second sensor to be, for example, a sensor that detects an area on the side of the vehicle M in the travel direction.

Priority means that, for example, a detection result of a prioritized sensor is given more importance when the surroundings are recognized. For example, the surroundings are recognized using the detection result of the prioritized sensor without using the detection results of other sensors. The weight of use of the detection result of the prioritized sensor may be made greater than the weight of use of the detection result of a non-prioritized sensor. For example, if the driving assistance device 100 recognizes a type of physical object, a position of the physical object, and the like by combining scores based on the detection results of the sensors, the weight of the detection result of the prioritized sensor may be made greater than the weight of the detection result of the non-prioritized sensor when the scores are combined.

Prioritizing may also be as follows. For example, when the position (first position) of the physical object obtained from the detection result of the prioritized sensor is different from the position (second position) of the physical object obtained from the detection result of the non-prioritized sensor, the driving assistance device 100 may estimate the first position as the position of the physical object or may estimate that the physical object is located at a position obtained by shifting the first position toward the second position by a predetermined degree.

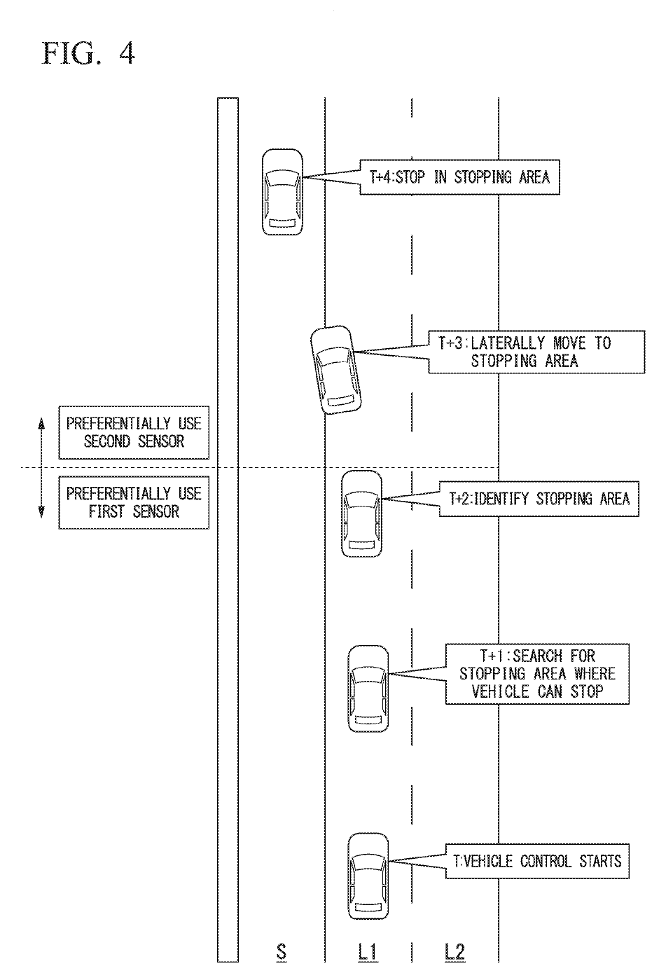

FIG. 4 is an explanatory diagram of a process executed by the driving assistance device 100. The road includes a lane L1, a lane L2, and a road shoulder S adjacent to lane L1. The vehicle M is traveling in the lane L1.

At time T, when an abnormality occurs in the vehicle M or the driver, the driving assistance device 100 starts the vehicle control and starts deceleration.

At time T+1, while continuing deceleration, the driving assistance device 100 searches for a stopping area where the vehicle M can be stopped. The stopping area is an area such as a road shoulder that does not relatively obstruct the progress of other traffic participants such as other vehicles. After the vehicle control starts, the driving assistance device 100 may laterally move the vehicle M in the direction of an area such as the road shoulder side where the passage of other traffic participants is not obstructed within the lane L1. When the vehicle M is traveling in the lane L2, the driving assistance device 100 may automatically change the lane of the vehicle M to the lane L1 on the road shoulder side.

At time T+2, the driving assistance device 100 identifies a stopping area. The driving assistance device 100 searches for and identifies the stopping area by prioritizing the detection result of the first sensor over the detection result of the second sensor.

At time T+3, when the speed of the vehicle M falls below the predetermined speed, the driving assistance device 100 gives priority to the detection result of the second sensor and laterally moves the vehicle M toward the stopping area. For example, the driving assistance device 100 may prioritize the detection result of the second sensor over the detection result of the first sensor to laterally move the vehicle M after the stopping area is identified or may give priority to the detection result of the second sensor to laterally move the vehicle M toward the stopping area when the stopping area is identified and the speed of the vehicle M falls below the predetermined speed.

The driving assistance device 100 may maintain the speed of the vehicle M above the predetermined speed until the stopping area is identified, control the vehicle M’s speed below the predetermined speed after identifying the stopping area, and then preferentially use the detection result of the second sensor.

Before the stopping area is identified, when the speed of the vehicle M falls below the predetermined speed, the driving assistance device 100 may preferentially use the detection result of the second sensor. In this case, the driving assistance device 100 may give priority to the detection result of the first sensor to search for and identify the stopping area or may give priority to the detection result of the second sensor to search for and identify the stopping area. The driving assistance device 100 may also search for and identify the stopping area using the detection result of the first sensor and the detection result of the second sensor. In the following description, it is assumed that the detection result of the second sensor is prioritized because the stopping area is identified and the speed of the vehicle M falls below the predetermined speed.

At time T+4, the driving assistance device 100 gives priority to the detection result of the second sensor to laterally move the vehicle M while continuing to decelerate. The driving assistance device 100 laterally moves the vehicle M to an area to which the vehicle M can move to the side of the vehicle M (e.g., a stopping area such as a road shoulder) by controlling the steering of the vehicle M based on the detection result of the second sensor. The driving assistance device 100 may laterally move the vehicle M (for example, toward the road shoulder side) before time T+3 and execute control (second lateral movement control) for further moving the vehicle M to an area in a lateral direction where the vehicle M can move found in a search based on the detection result of the second sensor, based on the position after the lateral movement at time T+4.

Also, the driving assistance device 100 stops the vehicle M in the stopping area. After the start of execution of the vehicle control, when a predetermined time has elapsed or when the vehicle M has traveled a predetermined distance, the driving assistance device 100 stops the vehicle M.

As described above, the driving assistance device 100 can more appropriately control the vehicle M using the appropriate one of the first sensor and the second sensor in accordance with the speed of the vehicle M. For example, when the speed of the vehicle M exceeds the predetermined speed, the driving assistance device 100 actively uses the first sensor, which can accurately detect a distant area, to search for an area where the vehicle M can stop or an area that does not obstruct the movement of other traffic participants. When the speed of the vehicle M is lower than the predetermined speed, the driving assistance device 100 actively uses the second sensor, which can more accurately detect areas on the side of the vehicle M, to laterally move the vehicle M to the above-described area found in a previous search or an area near it. Thus, the driving assistance device 100 can guide the vehicle M to an appropriate area during an abnormal state by using sensors suitable for the vehicle M’s situation.

Although the case where there is no other vehicle in front of the vehicle M has been described in the above-described example, the following process may be executed when there is another vehicle. When there is a preceding vehicle in the travel direction of the vehicle M, the driving assistance device 100 controls a position of the vehicle M in the front-rear direction in the vehicle control based on information about the preceding vehicle included in the detection result of the first sensor to execute control for moving the vehicle in the lateral direction in the vehicle control based on the detection result of the second sensor (first lateral movement control). In this case, the driving assistance device 100 can appropriately control the vehicle M while maintaining an appropriate position with respect to the preceding vehicle.

### Stepwise switching

The driving assistance device 100 may gradually (or stepwise) switch a priority level for using the detection result of the first sensor and a priority level for using the detection result of the second sensor. For example, in vehicle control for decelerating and stopping the vehicle M when an abnormality occurs in the vehicle M or the driver of the vehicle M, the driving assistance device 100 may decrease the priority level for using the detection result of the first sensor and increase the priority level for using the detection result of the second sensor in accordance with the decrease in the speed of the vehicle M after the start of vehicle control or in accordance with the elapse of time from the start of vehicle control, thereby recognizing the surroundings of the vehicle M and stopping the vehicle based on a recognition result.

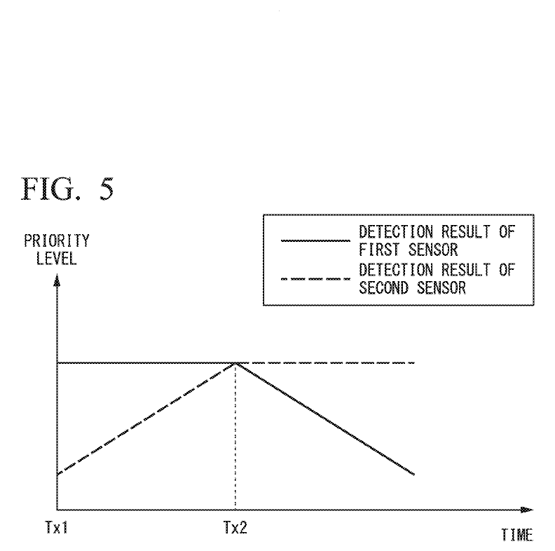

FIG. 5 is an explanatory diagram of an example of a process of switching the priority level. The vertical axis of FIG. 5 represents a priority level and the horizontal axis represents time. It is assumed that an abnormality occurs at time Tx1. At this time, the driving assistance device 100 preferentially uses the detection result of the first sensor over the detection result of the second sensor. As time elapses, the priority level of the detection result of the second sensor increases.

For example, from time Tx1 to time Tx2 when a predetermined time has elapsed, for example, the priority level of the detection result of the first sensor remains constant. At time Tx2, the priority level of the detection result of the first sensor decreases with the elapse of time. For example, the priority level of the detection result of the second sensor remains constant from time Tx2. In this way, the priority levels of the detection results of the sensors change with the elapse of time.

Although the case where the priority level of the detection result of the sensor changes with the elapse of time has been described above, the priority level may alternatively change according to the speed of the vehicle M. For example, the timing when the speed of the vehicle M is less than or equal to a threshold may be the timing of time Tx2.

As described above, because the driving assistance device 100 adjusts the priority level in accordance with time or speed, searches for an area where the vehicle M can accurately stop, and appropriately laterally moves the vehicle M to the area found in the search, the vehicle M can smoothly move to and stop in an appropriate area.

### Flowchart

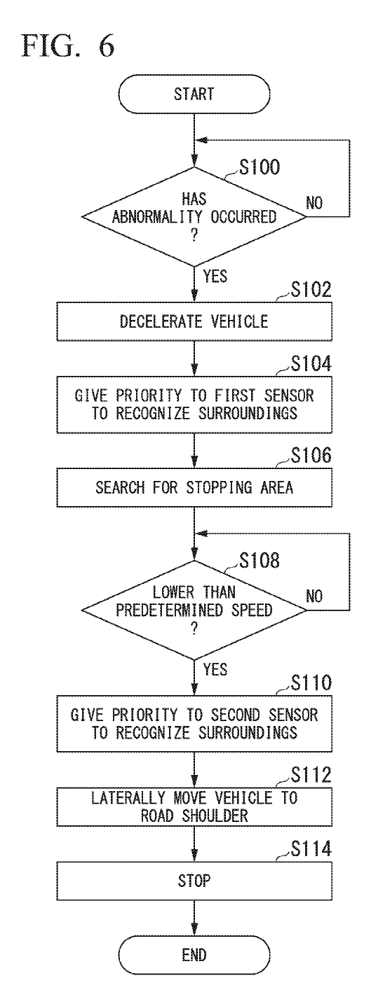

FIG. 6 is a flowchart showing an example of a process executed by the driving assistance device 100. First, the driving assistance device 100 determines whether or not an abnormality has occurred (step S100). When an abnormality has occurred, the driving assistance device 100 decelerates the vehicle M (step S102). At this time, the driving assistance device 100 gives priority to a detection result of the first sensor to recognize surroundings (step S104).

Subsequently, the driving assistance device 100 searches for a stopping area (step S106). A process for searching for the stopping area in step S106 may be started at any timing when the abnormality has occurred in step S100. Subsequently, the driving assistance device 100 determines whether or not the speed of the vehicle M is lower than a predetermined speed (step S108). When the speed of the vehicle M is lower than the predetermined speed, the driving assistance device 100 gives priority to the detection result of the second sensor to recognize the surroundings (step S110). Subsequently, the driving assistance device 100 laterally moves the vehicle M to a stopping area such as a road shoulder (step S112), and stops the vehicle M in the stopping area (step S114). Thereby, the process of one routine of the present flowchart is completed. In addition, instead of the speed of the vehicle M, the elapsed time from the occurrence of the abnormality may be used for determination in the above-described process.

According to the above process, the driving assistance device 100 can appropriately control the vehicle M.

According to the embodiment described above, in vehicle control for decelerating and stopping a vehicle, the driving assistance device 100 gives priority to a detection result of a first sensor to execute the vehicle control when a speed of the vehicle is higher than or equal to a predetermined speed and gives priority to a detection result of a second sensor to execute the vehicle control when the speed of the vehicle is lower than the predetermined speed, thereby appropriately controlling the vehicle M.

The embodiment described above can be represented as follows.

A control device including:

A storage device storing a program; and a hardware processor, the hardware processor executing the program stored in the storage device to: in vehicle control for decelerating and stopping a vehicle, give priority to a detection result of a first sensor to execute the vehicle control when a speed of the vehicle is higher than or equal to a predetermined speed; and give priority to a detection result of a second sensor to execute the vehicle control when the speed of the vehicle is lower than the predetermined speed, wherein the first sensor, which is provided around the vehicle and detects surroundings of the vehicle, can detect a situation of an area farther away than the second sensor, and wherein the second sensor, which is provided around the vehicle and detects the surroundings of the vehicle, has higher detection accuracy for a situation of a nearby area than the first sensor.

Although modes for carrying out the present invention have been described using embodiments, the present invention is not limited to the embodiments and various modifications and substitutions can also be made without departing from the scope of the present invention.

What is claimed is:

1. A vehicle control device comprising:
a first sensor provided around a vehicle and configured to detect surroundings of the vehicle;
a second sensor provided around the vehicle and configured to detect the surroundings of the vehicle; and
a controller configured to control the vehicle,
wherein the first sensor is configured to detect a situation of an area farther away than the second sensor,
wherein the second sensor has higher detection accuracy for a situation of a nearby area than the first sensor, and
wherein, in vehicle control for decelerating and stopping the vehicle, the controller
gives priority to a detection result of the first sensor to execute the vehicle control when a speed of the vehicle is higher than or equal to a predetermined speed, and
gives priority to a detection result of the second sensor to execute the vehicle control when the speed of the vehicle is lower than the predetermined speed.

2. The vehicle control device according to claim 1, wherein the second sensor is a sensor configured to detect the surroundings of the vehicle when the vehicle is parked or departs from a parking space.

3. The vehicle control device according to claim 1,
wherein the second sensor detects an area on a side of the vehicle in a travel direction, and
wherein, in the vehicle control for decelerating and stopping the vehicle, the controller causes the vehicle to laterally move to an area where the vehicle can move to the side by controlling steering of the vehicle based on the detection result of the second sensor.

4. The vehicle control device according to claim 3, wherein, when a preceding vehicle is located in the travel direction of the vehicle, the controller
controls a position of the vehicle in a front-rear direction in the vehicle control based on information about the preceding vehicle included in the detection result of the first sensor, and
executes first lateral movement control for laterally moving the vehicle in the vehicle control based on the detection result of the second sensor.

5. The vehicle control device according to claim 3, wherein the controller executes second lateral movement control for laterally moving the vehicle and, based on a position after the lateral movement, further moving the vehicle to an area in a lateral direction where the vehicle is movable found in a search based on the detection result of the second sensor.

6. The vehicle control device according to claim 1, wherein the controller stops the vehicle when a predetermined time has elapsed after a start of execution of the vehicle control or when the vehicle has traveled a predetermined distance.

7. The vehicle control device according to claim 1, wherein the controller starts the vehicle control when an abnormality has occurred in a driver of the vehicle.

8. The vehicle control device according to claim 1, wherein the controller
starts the vehicle control when an abnormality has occurred in the vehicle or in a driver of the vehicle,
gives the priority to the detection result of the first sensor to execute the vehicle control and searches for a candidate for a stopping area for stopping the vehicle by preferentially using the detection result of the first sensor, when the speed of the vehicle is higher than or equal to the predetermined speed, and
gives the priority to the detection result of the second sensor to execute the vehicle control and causes the vehicle to laterally move to a candidate for the stopping area or a nearby area of the candidate for the stopping area, when the speed of the vehicle is lower than the predetermined speed.

9. A vehicle control device comprising:
a first sensor provided around a vehicle and configured to detect surroundings of the vehicle;
a second sensor provided around the vehicle and configured to detect the surroundings of the vehicle; and
a controller configured to control the vehicle,
wherein the first sensor is configured to detect a situation of an area farther away than the second sensor,
wherein the second sensor has higher detection accuracy for a situation of a nearby area than the first sensor, and
wherein, in vehicle control for decelerating and stopping the vehicle when an abnormality has occurred in the vehicle or a driver of the vehicle,
the controller decreases a priority level for using a detection result of the first sensor and increases a priority level for using a detection result of the second sensor in accordance with a decrease in a speed of the vehicle after a start of the vehicle control or in accordance with an elapse of time from the start of the vehicle control, thereby recognizing the surroundings of the vehicle and causing the vehicle to stop based on a recognition result.

10. A vehicle control method comprising:
in vehicle control for decelerating and stopping a vehicle,
giving, by a computer, priority to a detection result of a first sensor and executing the vehicle control when a speed of the vehicle is higher than or equal to a predetermined speed; and
giving, by the computer, priority to a detection result of a second sensor and executing the vehicle control when the speed of the vehicle is lower than the predetermined speed,
wherein the first sensor, which is provided around the vehicle and detects surroundings of the vehicle, is configured to detect a situation of an area farther away than the second sensor, and
wherein the second sensor, which is provided around the vehicle and detects the surroundings of the vehicle, has higher detection accuracy for a situation of a nearby area than the first sensor.

11. A computer-readable non-transitory storage medium storing a program for causing a computer to execute:
in vehicle control for decelerating and stopping a vehicle,
a process for giving priority to a detection result of a first sensor to execute the vehicle control when a speed of the vehicle is higher than or equal to a predetermined speed; and
a process for giving priority to a detection result of a second sensor to execute the vehicle control when the speed of the vehicle is lower than the predetermined speed,
wherein the first sensor, which is provided around the vehicle and detects surroundings of the vehicle, is configured to detect a situation of an area farther away than the second sensor, and
wherein the second sensor, which is provided around the vehicle and detects the surroundings of the vehicle, has higher detection accuracy for a situation of a nearby area than the first sensor.
